(19) United States
(12) Patent Application Publication
(10) Pub. No.: US 2013/0207496 A1
(43) Pub. Date: Aug. 15, 2013

(54) SYSTEM AND METHOD FOR PERFORMING MAGNETIC LEVITATION IN AN ENERGY STORAGE FLYWHEEL

(71) Applicant: SPINLECTRIX INC., (US)

(72) Inventor: Jonathan Forrest Garber, Hillsborough, CA (US)

(73) Assignee: SPINLECTRIX INC., Hillsborough, CA (US)

(21) Appl. No.: 13/840,308

(22) Filed: Mar. 15, 2013

Related U.S. Application Data
(63) Continuation-in-part of application No. 13/280,232, filed on Oct. 24, 2011.
(60) Provisional application No. 61/406,099, filed on Oct. 22, 2010.
(60) Provisional application No. 61/406,102, filed on Oct. 22, 2010.
(60) Provisional application No. 61/406,103, filed on Oct. 22, 2010.
(60) Provisional application No. 61/406,104, filed on Oct. 22, 2010.
(60) Provisional application No. 61/406,105, filed on Oct. 22, 2010.
(60) Provisional application No. 61/406,107, filed on Oct. 22, 2010.

(51) Int. Cl. F16C 32/04

(52) U.S. Cl. CPC F16C 32/0444; F16C 32/0459
USPC 310/90.5

(57) ABSTRACT

A system for performing magnetic levitation of an energy storage flywheel, including an upper levitator pole which includes a permanent magnet and an electromagnet, a lower levitator pole fixed to the energy storage flywheel and being formed of a material capable of being attracted to or repelled from the upper levitator pole when a magnetic flux is applied to the magnetic flux path of the permanent magnet of the upper levitator pole, an electromagnetic driver which applies an electric current through the electromagnet of the upper levitator pole, and a controller which controls the electromagnetic driver so as to control the electric current applied through the electromagnet, causing the lower levitator pole to be controllably attracted to or repelled from the upper levitator pole.

### CROSS-REFERENCE TO RELATED APPLICATIONS

This application is a continuation-in-part of U.S. patent application Ser. No. 13/280,232, filed Oct. 24, 2011, titled “Stabilization of Flywheels,” which claims priority to U.S. Provisional Application No. 61/406,099, filed Oct. 22, 2010, titled “Flywheel Structures,” U.S. Provisional Application No. 61/406,102, filed Oct. 22, 2010, titled “Method of Stabilization of Rotating Machinery,” U.S. Provisional Application No. 61/406,103, filed Oct. 22, 2010, entitled “Methods for Stabilization of Flywheels,” U.S. Provisional Application No. 61/406,104, filed Oct. 22, 2010, entitled “Kinetic Energy Storage Rotor Design,” U.S. Provisional Application No. 61/406,105, filed Oct. 22, 2010, entitled “Permanent Magnets for Flywheels,” and U.S. Provisional Application No. 61/406,107, filed Oct. 22, 2010, entitled “Concrete Vacuum Enclosures for Energy Storage Flywheels,” each of which are incorporated herein by reference in their entireties.

### BACKGROUND OF THE INVENTION

1. The Field of the Invention

The present invention relates to improved magnetic suspension for use in rotating machinery. More specifically, the present invention relates to improved magnetic suspension for use in flywheel energy storage systems.

2. The Relevant Technology

Magnetic suspension is the process of suspending a mass against the force of gravity using forces generated by magnetic fields. These magnetic fields may be produced by permanent magnets, electromagnets, or combinations thereof.

Magnetic suspension offers a number of advantages over other means of suspension, including the elimination of physical contact between the suspended artifact and its surroundings and the ability to control suspension characteristics through electromagnetic means.

Because of these benefits, the utility of magnetic suspension for rotating machines has long been recognized, and a rich variety of magnetic suspension art for rotating machines has been developed. A common type of magnetic suspension takes the form of magnetic bearings, which act to constrain a rotating artifact to a desired position through use of magnetic force rather than employing bearings dependent on physical contact between rotating and stationary components.

Within the variety of magnetic bearings that are currently used in the art are bearings which use permanent magnets, electromagnets, and combinations thereof, sometimes called hybrid magnets. Operation of magnetic bearings takes place in many modalities, from simple passive systems to active bearings that incorporate multiple sensors and sophisticated closed-loop control algorithms.

One particular application of magnetic bearing systems is in flywheels. An early example is found in “Passive Stabilization of Flywheel Magnetic Bearings,” by P. A. Basore, in which controllable electromagnetic axial and radial magnetic bearings are disclosed. Various other electromagnetic bearing systems as applied to energy storage flywheels are also known in the art.

A long-appreciated drawback of the controllable magnetic bearing systems as they are currently known in the art is that as the teachings are applied to energy storage flywheels, a substantial amount of electrical power is required to operate the magnetic bearings. This is a particular issue when controllable magnetic bearings are used to levitate or suspend a flywheel rotor against the pull of gravity, as the amount of electrical power required for levitation increases with the mass of the flywheel rotor. In some instances, where large amounts of energy are being stored, the mass of the flywheel rotor is large, meaning that a large amount of electrical power is required to levitate the flywheel rotor. This greatly increases the cost of maintaining a large capacity flywheel motor.

A second drawback of using the controllable magnetic bearings currently known in the art is that when they are used to suspend energy storage flywheel rotors, a variety of instabilities arise in spinning the rotors. In energy storage flywheels, controllable magnetic levitation bearings are typically deployed in pairs, with one bearing at each end of the flywheel rotor's principal axis of rotation, which may be horizontal or vertical according to particular flywheel application requirements. The use of two constraining bearings, whether magnetic or other bearing technology, induces well-known instabilities that cause synchronous and subsynchronous motions which are detrimental to efficient and reliable flywheel operation.

In order to overcome these drawbacks and limitations, a need has arisen for a magnetic suspension system for use in rotating machinery and flywheels which is able to provide a controlled levitation force with reduced power requirements and which is easily controlled without the resulting detrimental rotordynamic phenomena.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

These and other limitations are overcome by embodiments of the invention which relate to systems and methods for providing an improved magnetic suspension systems for rotating machinery, more specifically to magnetic suspension systems used in flywheel energy storage systems.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

A first aspect of the invention is a system for performing magnetic levitation of an energy storage flywheel. The system includes an upper levitator pole which includes a permanent magnet, an electromagnet and a magnetic flux path of the permanent magnet, a lower levitator pole fixed to the energy storage flywheel, the lower levitator pole being formed of a material capable of being attracted to or repelled from the upper levitator pole when a magnetic flux is applied to the magnetic flux path of the permanent magnet of the upper levitator pole, an electromagnetic driver which applies an electric current through the electromagnet of the upper levitator pole, and a controller which controls the electromagnetic driver so as to control the electric current applied through the electromagnet of the upper levitator pole so as to vary the magnetic flux applied to the magnetic flux path, causing the lower levitator pole to be controllably attracted to or repelled from the upper levitator pole.

A section aspect of the invention is a system for performing magnetic levitation of an energy storage flywheel which also provides multi-dimensional tilt control. The system includes an upper levitator pole which includes a permanent magnet, an magnetic flux path of the permanent magnet, and at least two independently operable electrical coils, a lower levitator pole fixed to the energy storage flywheel, the lower levitator pole being formed of a material capable of being attracted to or repelled from the upper levitator pole when a magnetic flux is applied to the magnetic flux path of the permanent magnet of the upper levitator pole, an electromagnetic driver which independently applies an electric current to each of the at least two independently operable electrical coils of the upper levitator pol, and a controller which controls the electromagnetic driver so as to independently control the electric current applied through each independently operable electrical coils of the upper levitator pole so as to vary the magnetic flux applied to the magnetic flux path, causing the lower levitator pole to be controllably attracted to or repelled from the upper levitator pole.

A third aspect of the invention is a method for performing levitation of an energy storage flywheel in a system including an upper levitator pole which includes a permanent magnet and an electromagnet, a lower levitator pole fixed to the energy storage flywheel, an electromagnetic driver, and a controller which controls the electromagnetic driver. The method includes providing a levitation force on the energy storage flywheel by controlling the electromagnetic driver using the controller so that an electric current is applied through the electromagnet of the upper levitator pole so as to apply a magnetic flux to a magnetic flux path formed between the upper levitator pole and the lower levitator pole, and causing the lower levitator pole to be controllably attracted to or repelled from the upper levitator pole by varying the electric current applied through the electromagnet of the upper levitator pole which varies the magnetic flux and attraction force between the upper levitator pole and the lower levitator pole.

In the system and methods described herein, a structure is constructed that incorporates a permanent magnet, an electromagnet, and a path for magnetic flux such that the magnetic flux originating in the permanent magnet creates a force that may attract or repel another structure. By means of varying the flow of electric current through the electromagnet, the net force exerted by the controlled structure upon another structure may be varied in a controllable manner.

This embodiments described herein mitigate and/or eliminate the two drawbacks described above by first providing a controllable magnetic levitation force that can fully levitate an energy storage flywheel rotor with very small or negligible electrical power requirements, and second, by levitating a flywheel rotor through use of a single controlled levitator, thereby avoiding excitation of a wide variety of detrimental rotordynamic phenomena which attend the use of more than a single levitator. A third advantage of this invention lies in an embodiment that provides, in addition to flywheel rotor levitation, the ability to control flywheel tilt about at least one axis perpendicular to the principal axis of rotation.

Another advantage of the embodiments described herein relates to its ability to reduce power consumed during operation. According to this invention, an electromagnet may be controlled so that nearly all the force needed to maintain position is provided by a permanent magnet, with the electromagnet modulating the force as required to maintain a desired position or force.

A further advantage of the embodiments is that they reduce or substantially eliminate a variety of instabilities that commonly increase the cost of flywheel energy storage systems and/or degrade their reliability and longevity.

A further advantage of at least some of the embodiments described herein is that they provide control over at least one axis of tilt of the rotor in addition to fulfilling its function of levitating the flywheel rotor.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a sectional view of a levitated flywheel rotor capable of performing aspects of the invention;

FIG. 2A is a sectional view of a controllable magnetic levitator pole assembly according to one embodiment of the invention;

FIG. 2B is an oblique view of the iron/steel component of a controllable magnetic Z axis levitator with the associated permanent ring magnet and electromagnetic coil omitted for clarity;

FIG. 2C is a schematic section view of a noncontrollable magnetic levitator pole assembly used in conjunction with the controllable levitator pole shown in FIG. 2A;

FIG. 2D is a schematic section view of an upper controllable magnetic levitator pole in opposition to a lower noncontrollable magnetic levitator pole which illustrates the alignment of magnetic vectors in the respective permanent magnets in each pole assembly;

FIG. 3 is a graph which illustrates the magnetic levitation force vs. control coil current at three different constrained separation distances between upper and lower levitation pole structures and which illustrates the levitation force obtained at the control coil power null for these separations;

FIG. 4A illustrates the lower face of a controllable magnetic levitator pole assembly according to one embodiment of the invention;

FIG. 4B is a sectional view along the B-B line of FIG. 4A which illustrates the controllable magnetic levitator pole of FIG. 4A;

FIG. 4C is a sectional view along the line C-C of FIG. 4A;

FIG. 5 illustrates the controllable magnetic levitator pole of FIG. 4A in opposition to a second magnetic levitator pole;

FIG. 6 illustrates a controllable magnetic levitator system with very low or substantially no restoring force in response to displacements of the lower levitator pole in at least one of the X or Y axes; and

FIG. 7 illustrates a method for performing magnetic levitation using the controllable magnetic levitator system of one embodiment of the invention.

### DETAILED DESCRIPTION OF THE PREFERRED EMBODIMENTS

Embodiments of the invention relate to improvements in magnetic suspension for rotating machinery or energy storage flywheels. As is described more fully below, the advantages of the embodiments described herein include reduced power consumption, additional control while providing additional degrees of freedom for the flywheel rotors and reducing any adverse rotordynamic phenomena.

While the figures described herein are illustrate configurations where the embodiments of the invention are applied to storage flywheels, the principles and teachings described herein may also be applied to other applications, including various types of rotating machinery. As such, the figures are not intended to limit the application of the principles taught herein to flywheels and may be used in other configurations without departing from the meaning or scope of the claims.

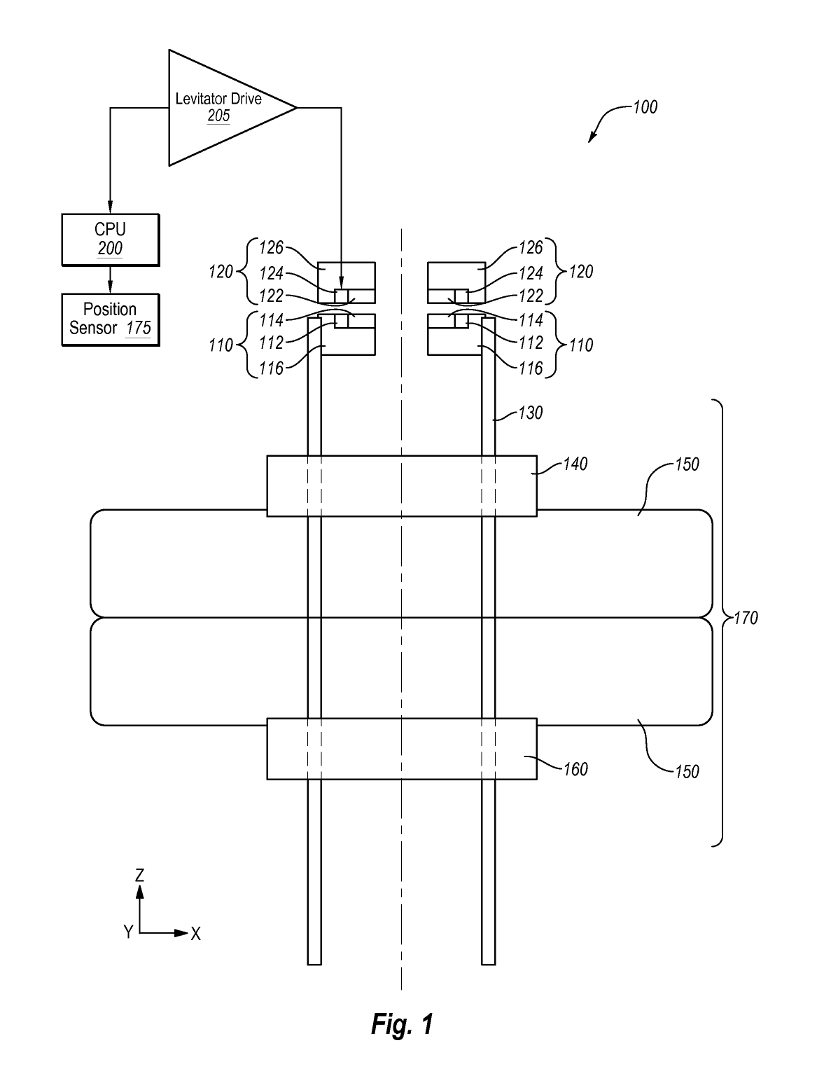

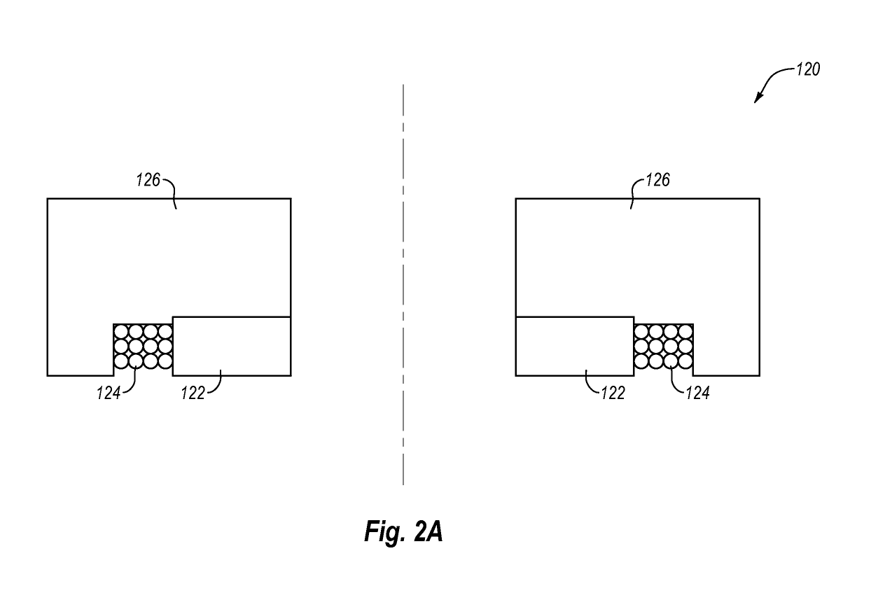

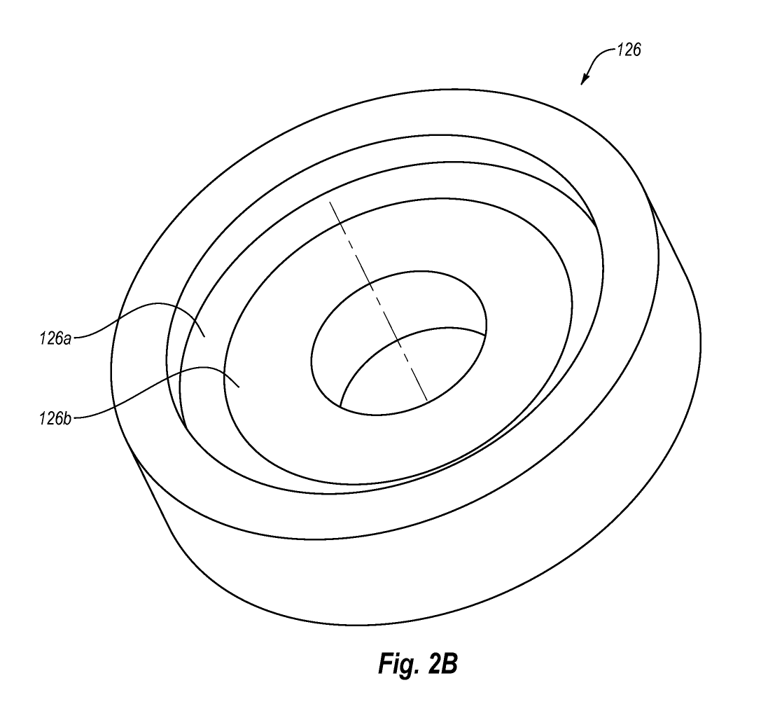

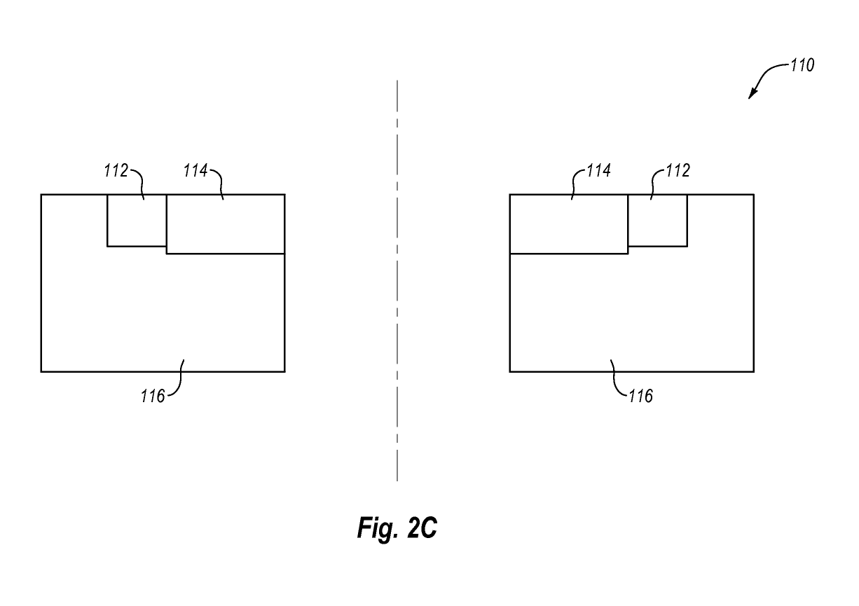

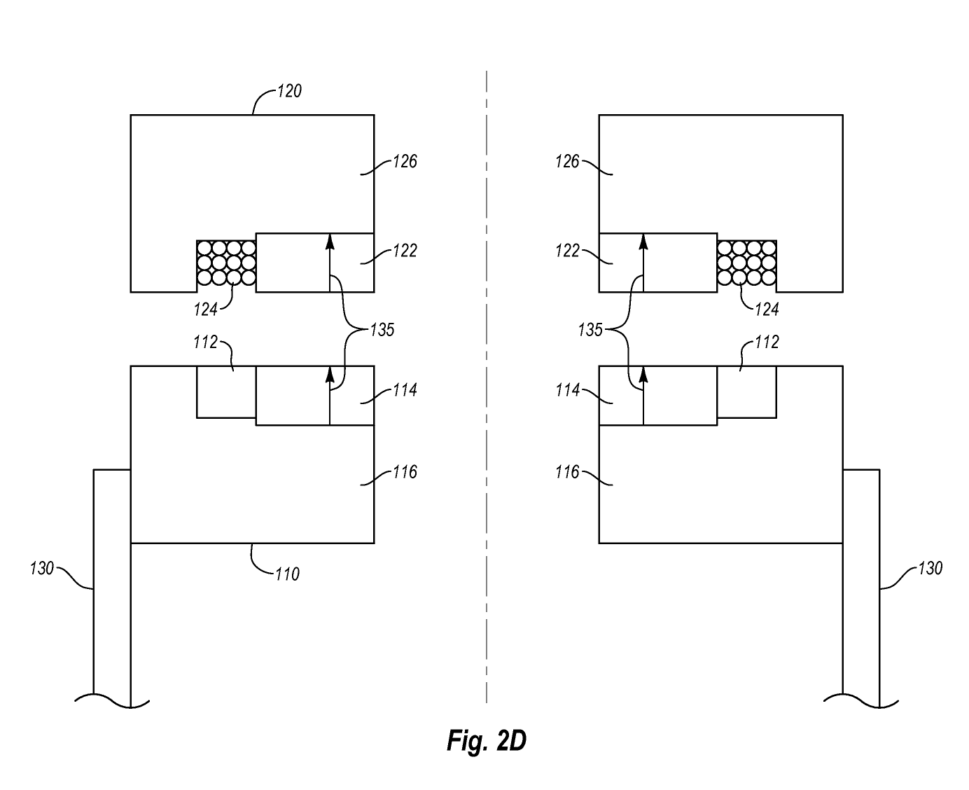

FIGS. 1-2D illustrate a magnetic suspension system for an energy storage flywheel 100 according to a first embodiment of the invention. FIG. 1 is a sectional view of the levitated flywheel rotor 170 which is levitated in the Z axis against the force of gravity by a magnetic levitator 180 that consists of an upper levitator pole 120 fixed to external means of support (not shown) and a lower levitator pole 110 that is attached to the upper portion of a flywheel rotor 170. In the embodiment shown in FIG. 1, some components of the flywheel system 100, including the stator coils and magnets that sustain motor/generator functions, are omitted for clarity.

The flywheel rotor 170 includes an upper retainer 140, a lower retainer 160 a pair of rotor discs 150 and a flywheel rotor tube which is connected to the lower levitator pole 110. A position sensor 175 or other means of sensing the position of the flywheel rotor 170 with respect to the Z axis is positioned in the proximity of the flywheel rotor 170 and is connected to a CPU 200 or other means of computation. The CPU 200 is connected to a levitator drive 205 or other means of driving a controllable electric current through an electromagnetic or control coil 124 contained within the upper levitator pole assembly 120. As is described more fully below, the upper levitator pole assembly 120 also includes an upper permanent ring magnet 122 and an upper levitator pole piece 126.

FIG. 2A illustrates the controllable upper levitator pole assembly 120 in closer detail. As shown therein, the upper levitator pole assembly 120 includes an upper levitator pole piece 126 which is preferably comprised of an iron alloy or steel structure. The upper levitator pole assembly 120 also contains a permanent ring magnet 122 and an electromagnetic levitation control coil 124 that is capable of modulating the magnetic force exerted along the Z axis so that a suspending magnetic force is applied to the flywheel rotor 170.

FIG. 2B is an oblique view of the upper levitator pole piece 126 where the associated permanent ring magnet 122 and electromagnetic levitation control coil are omitted for clarity. Specifically, as shown in FIG. 2B, the upper levitator pole piece 126 of one embodiment has an annulus shape with a surface 126a on which the electromagnetic coil 123 is disposed together with a surface 126b on which the upper permanent ring magnet 122 is disposed. The upper levitator pole piece 126 provides support to prevent the upper permanent ring magnet 122 from fracturing due to centripetal forces produced by high rotation speeds.

In a preferred embodiment, the upper levitator pole piece 126 is fabricated from 1018 steel in the form of a torus having an outside diameter of 3.125 inches, an inner diameter of 1.00 inches, and a maximum height of 0.75 inches, according to the schematic sectional view of FIG. 2A and the oblique view of FIG. 2B. Within a central concentric relief feature is located the permanent ring magnet 122 consisting of a neodymium-iron-boron composition of minimum magnetic material grade 42. The permanent ring magnet 122 has an outer diameter of 2.00 inches, an inner diameter of 1.00 inch, and a thickness of 0.25 inch. The permanent ring magnet 122 is magnetized through its minor thickness and is installed in the upper levitator pole piece 126 so that its south magnetic pole is exposed. In a preferred embodiment, the permanent ring magnet 122 is affixed to the upper levitator pole piece 126 with a thin layer of cyanoacrylate adhesive.

Surrounding the permanent ring magnet 122 is placed a solenoid, or helically-wound electromagnetic levitation control coil 124, preferably consisting of 55 turns of insulated #22 gauge magnet wire, said electromagnetic levitation control coil 124 being wound so that it substantially fills the annulus between the outer diameter of the permanent ring magnet 122 and the inner diameter of an annular relief feature in the iron upper levitator pole piece 126 so it that provides space for the electromagnetic levitation control coil 124. The terminal ends of the electromagnetic levitation control coil 124 are connected to electronic drive elements, such as the levitator drive 205, so that controlled electric current flows through the electromagnetic levitation control coil 124 in response to control commands generated by computational means or CPU 200 as is described more fully below. Although not limiting, in this embodiment, the electromagnetic levitation control coil 124 is connected to field effect power transistors and power sources as is well known in the art of electromagnetic power circuitry.

FIG. 2C is a schematic section view of the noncontrollable or lower levitator pole assembly 110 used in conjunction with the controllable upper levitator pole assembly 120, as shown in FIG. 2A. The lower levitator pole assembly 110 includes a lower levitator pole piece 116 consists of an iron alloy structure which houses a permanent ring magnet 114 and a region of mechanical reinforcing material or a reinforcement ring 112 surrounding the permanent ring magnet 114.

The lower levitator pole assembly 120 fabricated in a similar manner than the upper levitator pole assembly 120. Preferably, the lower levitator pole assembly 120 includes a lower levitator pole piece 116 formed from 1018 steel having the dimensions similar to those described above with respect to the upper levitator pole piece 126, and permanent ring magnet 114 similar to the permanent ring magnet 122 is affixed to the lower levitator pole piece 116 as described above. The permanent ring magnet 114 is magnetized through its minor thickness and is installed in the lower levitator pole piece 116 so that its north magnetic pole is exposed.

In an annulus of the lower levitator pole piece 116 where the electromagnetic levitation control coil 124 is housed in the similarly shaped upper levitator pole piece 126, a reinforcement ring 112 of material is formed so as to surround the outer cylindrical surface of the permanent ring magnet 114. The reinforcement ring 112 provides support to prevent the permanent ring magnet 114 from fracturing due to centripetal forces produced by high rotation speeds. This reinforcement ring 112 or material may be fabricated as a separate component and installed, or may be formed in place as, for example, a glass fiber-reinforced liquid epoxy adhesive that subsequently cures in place. The material comprising the reinforcement ring 112 used should have a relative magnetic permeability of not more than approximately 1.0 to avoid substantially interacting with or distorting the magnetic flux pattern established by the permanent ring magnets 114 and 122, their supporting steel poles and the electromagnetic levitation control coil 124.

FIG. 2D is a schematic sectional view of the controllable upper levitator pole assembly 120 formed in opposition to the noncontrollable lower levitator pole assembly 110 and shows the alignment of magnetic vectors 135 in the respective permanent ring magnets 114 and 112 in each magnetic levitator pole assembly 110 and 120. The magnetic vectors 135 are aligned so that the two magnetic levitator pole assemblies 110 and 120 are in mutual attraction.

The levitation assembly of the flywheel system 100 according to this embodiment provides, in addition to a magnetic force that levitates the flywheel rotor 170 against gravity on the Z axis, a lesser force that tends to maintain concentricity between the upper levitator pole assembly 120 and the lower levitator pole assembly 110, thereby centering the flywheel rotor 170 against radial perturbations. This centering force is not a limitation of this invention, and the invention is operative in magnetic levitation configurations that do not provide this centering force.

Subsequently, the upper levitator pole assembly 120 is fixed to a support structure (not depicted) that is capable of supporting at least the full weight of the flywheel rotor 170 to be levitated. The lower levitator pole assembly 130 is fixed to the upper portion of the flywheel rotor tube 130 or shaft in a configuration which places the exposed permanent ring magnets 114 and 122 of the lower levitator pole assembly 110 and upper levitator pole assembly 120, respectively, in substantially planar and concentric opposition when the flywheel system 100 is operable.

Returning to FIG. 1, the two flywheel rotor discs 150 are subsequently affixed to the rotor tube 130, said rotor discs 150 consisting of 7075 aluminum alloy material and each weighing approximately 10 kg. The full weight of the flywheel rotor 170 when fully assembled is approximately 25 kg. Means by which the flywheel rotor 170 is accelerated and decelerated in spin about the Z axis are not depicted and are not critical to, nor limiting of, this invention. Examples of operable means include an array of permanent magnets affixed to the inner diameter of the flywheel rotor tube 130, with a concentric interior stator carrying suitable electromagnetic drive coils immersed within the rotor tube magnetic array, according to practice long established in the art of energy storage flywheels.

As described above, the flywheel system 100 is equipped with a position sensor 175 or other means of sensing the flywheel rotor's 170 position with respect to the Z axis, and is further equipped with a CPU 200 whereby data from the rotor Z axis position sensor 175 may be processed to determine the flywheel rotor's 170 position on the Z axis, and to compute corrective signals which, when applied to levitator drive 205, causes a controlled current to flow through the electromagnetic levitation control coil 124.

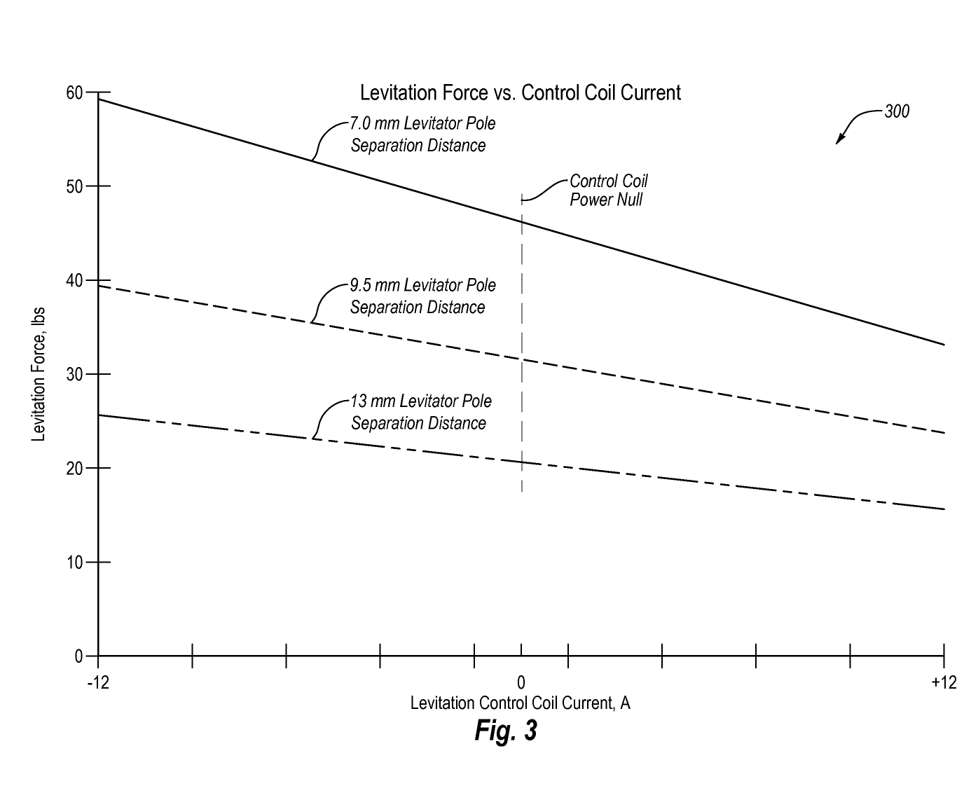

FIG. 3 depicts the nominal variation in levitation force caused by varying the electric current applied through the electromagnetic levitation control coil 124 at three different separation distances between upper levitator pole assembly 120 and the lower levitator pole assembly 110. More specifically, FIG. 3 displays the resulting magnetic levitation force at various currents applied to electromagnetic levitation control coil 124 when the upper levitator pole assembly 120 is spaced 7.0 millimeters, 9.5 millimeters, and 13 millimeters from the lower levitator pole assembly 120. Finally, FIG. 3 also shows levitation force obtained at the electromagnetic levitation control coil power null for these respective separations.

Although this preferred embodiment employs rare earth permanent magnets, 1018 alloy steel material, and a structure based on substantially circular or toroidal symmetry, these are not limiting aspects of this invention. The invention contemplates use of, for example, ceramic magnetic materials such as strontium iron ferrites including C8 grade or equivalent, and use of ferromagnetic materials other than 1018 steel, and use of other geometric design symmetries that may be better suited to the requirements of a particular application, none of these being a limitation on the invention.

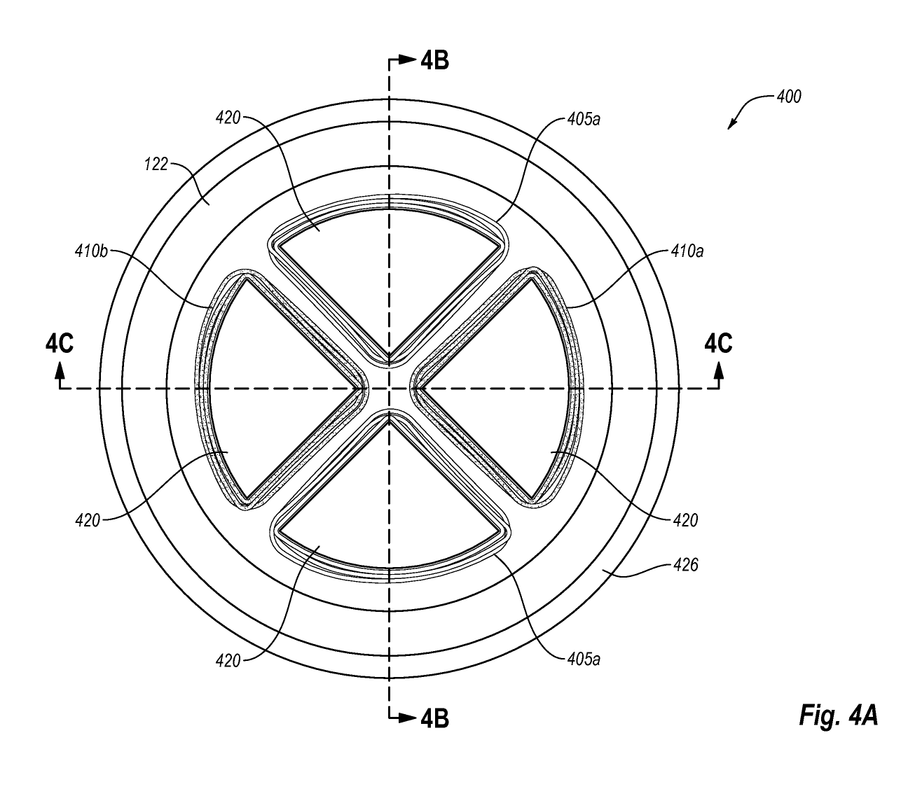

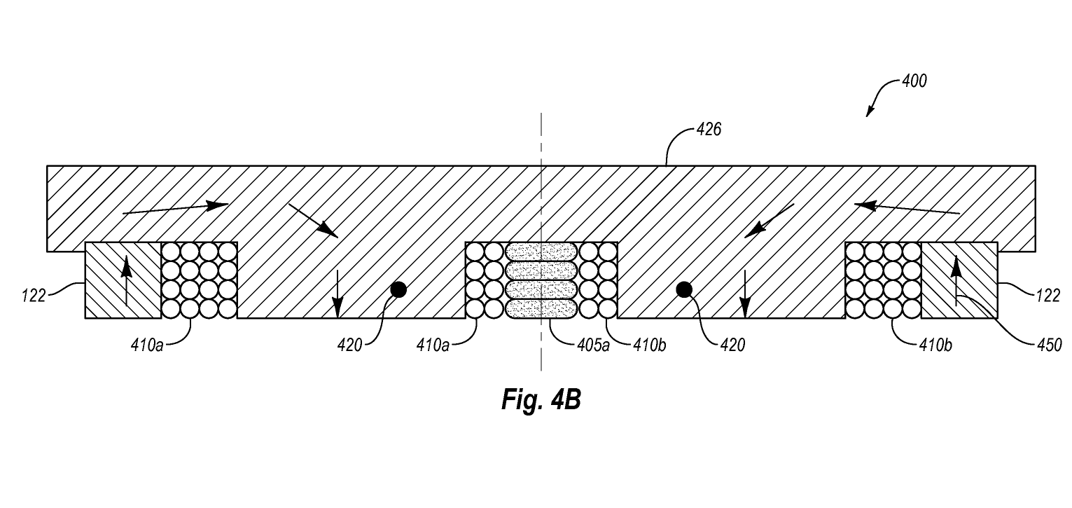

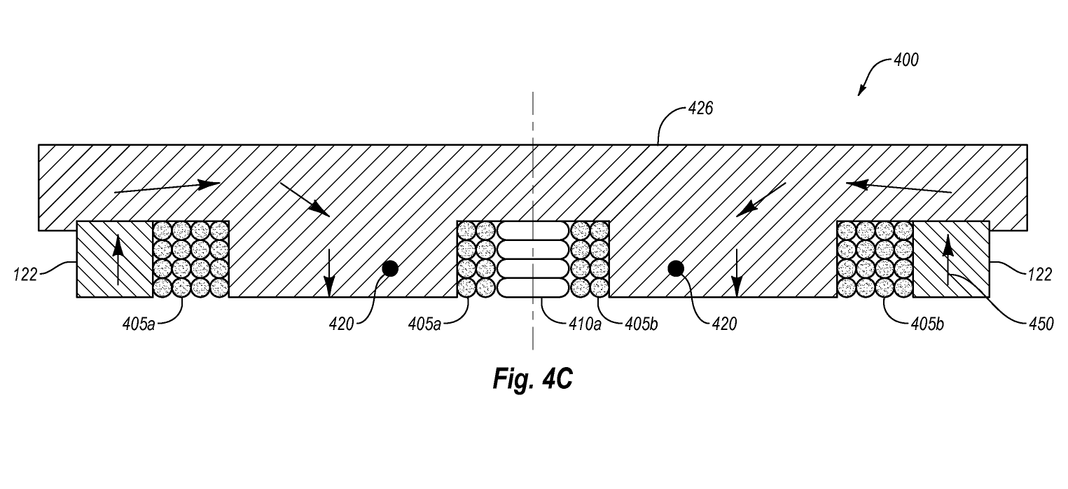

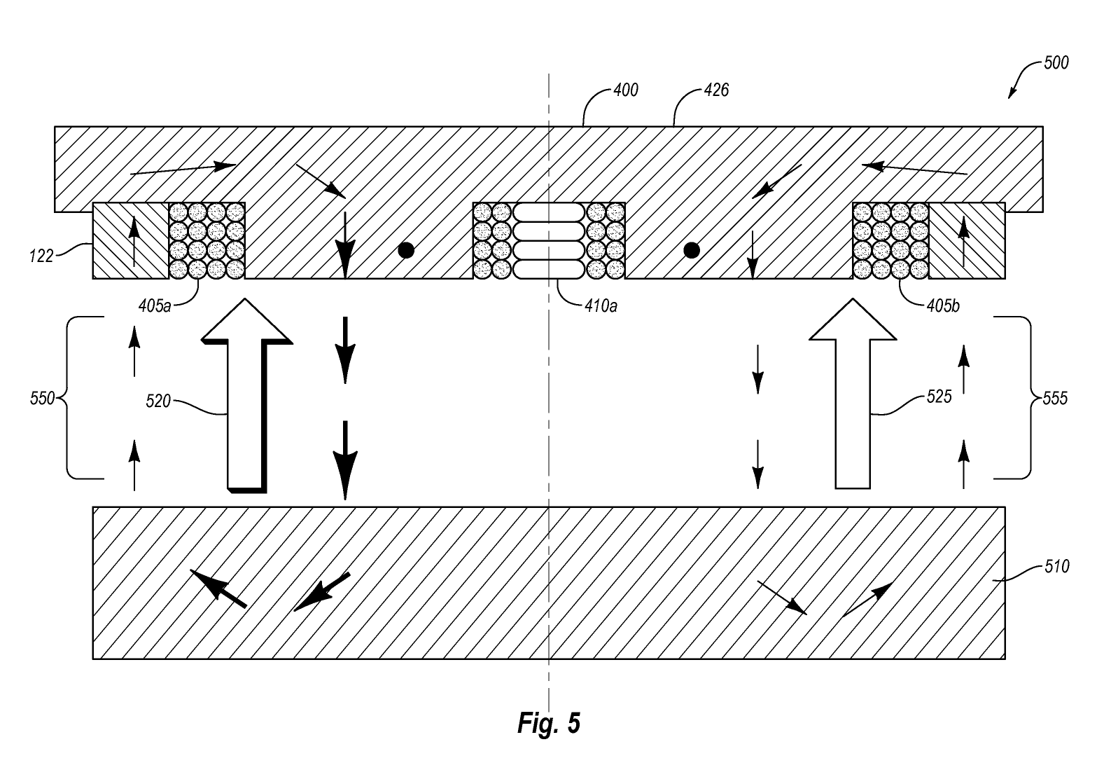

FIGS. 4A-4D along with FIG. 5 illustrate an upper levitator pole assembly 400 according to an alternate embodiment of the invention. In this alternative embodiment, the upper levitator pole assembly 400 includes an upper levitator pole piece 426 with a shape which differs from that shown in the first embodiment shown in FIGS. 1-2D. Specifically, in this embodiment, the upper levitator pole piece 426 consists of an iron alloy (1018 steel) structure which houses one permanent ring magnet 122 and four electromagnetic levitation control coils 405a-405b and 410a-410b which are capable of modulating the magnetic force exerted by the upper levitator pole assembly 400 on an external magnetic component (such as those in the lower levitator pole assembly 110) such that the magnetic force may be controllably made asymmetric with respect to the Z axis. One benefit of this asymmetry is that this asymmetrical magnetic force may inducing a tilt of the external magnetic component housed within a levitated component, while simultaneously providing enough force to levitate said component.

FIG. 4A illustrates the upper levitator pole assembly 400 as viewed from the surface of the upper levitator pole assembly 400 facing a lower levitator pole assembly 500. FIG. 4B is a schematic depiction of the controllable upper levitator pole assembly 400 of FIG. 4A, as seen in a face view of a section taken along the X axis and the sectional line B-B. Magnetic flux is depicted schematically with vector arrowhead 450 representing north. FIG. 4C is a schematic depiction of the upper levitator pole assembly 400 of FIG. 4A, as seen in a face view of a section taken along the Y axis and sectional line C-C. Magnetic flux is depicted schematically with vector arrowhead 450 representing north.

The upper levitator pole assembly 400 of this configuration includes a permanent ring magnet 122 having an inner diameter of three inches, an outer diameter of four inches, and a thickness of 0.5 inches, consisting of a rare earth magnetic composition of at least grade 42 and having a magnetization vector along its cylindrical axis. The permanent ring magnet 122 is affixed to a steel upper levitator pole piece 426 as depicted in FIG. 4A such that its north magnetic pole is placed in contact with the steel upper levitator pole piece 426. The permanent ring magnet 122 is secured to the upper levitator pole piece 426 with cyanoacrylate adhesive or other suitable adhesive. In a preferred embodiment, the upper levitator pole piece 126 is fabricated from an iron alloy known as 1018 steel.

In this embodiment, the upper levitator pole piece 426 includes four protruding steel poles 420 as shown in FIG. 4A, around each of which is wound a separate electromagnetic levitation control coil 405a-405b and 410a-410b. In one preferred embodiment, each electromagnetic levitation control coil 405a-405b and 410a-410b comprises 35 turns of #20 copper insulated magnet wire, each with connecting leads (omitted for clarity) connected to a controllable power source or levitator drive 205 such that a controlled electric current of selectable polarity may be caused to flow through each electromagnetic levitation control coil 405a-405b and 410a-410b, substantially independently of each other.

FIG. 5 is a schematic depiction of the controllable upper levitator pole assembly 400 of FIG. 4A in opposition to an alternative lower levitator pole assembly 510 to form a second embodiment of a levitation system of a flywheel assembly 500. In this embodiment, the lower levitator pole assembly 510 consists solely of 1018 magnetic steel alloy. In the configuration shown in FIG. 5, the first Y axis electromagnetic levitation control coil 405a is energized so as to reinforce or strengthen the local magnetic flux originating from the permanent ring magnet 122 mounted on the upper levitator pole piece 426. The second Y axis electromagnetic levitation control coil 405b is shown energized so as to oppose the local magnetic flux originating from the permanent ring magnet 122 mounted on the upper levitator pole piece 126. The imbalanced attraction forces between the two poles of the upper levitator pole assembly 400 are depicted as 520 and 525, respectively, with 520 indicating a larger attraction force due to a stronger magnetic flux 550 applied by the first Y axis electromagnetic levitation coil 405a. 525 indicates a smaller attraction force due to a weaker magnetic flux 555 applied by the second Y axis electromagnetic levitation coil 405b.

In operation, the upper levitator pole assembly 400 forms the upper pole of a levitation pole pair, as depicted in FIG. 5, in which a simple lower levitator pole assembly 510 is fabricated from 1018 magnetic steel is placed in opposition to the upper levitator pole assembly 400. In one preferred embodiment, the lower levitator pole assembly 510 has an outer diameter of four inches and a thickness of one inch. As with the first embodiment, a flywheel rotor assembly 170 (not depicted) is attached to the lower levitator pole assembly 510 and may thereby be supported against the force of gravity.

In operation, electric current flow to each of the four electromagnetic levitation control coils 405a-405b and 410a-410b is modulated so as to maintain the lower levitator pole assembly 510 and attached flywheel rotor assembly 170 in a desired levitated position on the vertical, or Z axis. Further, in response to the position sensor(s) 175, the CPU 200, and the levitator drive 205, the current applied to the four electromagnetic levitation control coils 405a-405b and 410a-410b are varied so as to strengthen or weaken the local magnetic flux arising from the permanent ring magnet 122 housed within the upper levitator pole assembly 400. This procedure causes local variations in the attractive forces present between the upper levitator pole assembly 400 and the lower levitator pole assembly 510. These local variations in force may be generated in either the X axis or the Y axis, or in both axes, according to which control coils are selected to cause unequal forces to be exerted on the lower levitator pole assembly 510. The generation of differential attractive forces causes the lower levitator pole assembly 510 to tilt about the X and/or Y axes, thereby causing the attached flywheel rotor assembly 170 to tilt in response to control system commands of the CPU 200.

Although in this embodiment, the lower levitator pole assembly 510 comprises a single piece of 1018 magnetic steel, in alternative embodiments, the lower levitator pole assembly 510 may incorporate one or more permanent magnets as may be dictated by levitation force requirements, and this is contemplated by the instant invention. It is further apparent that a smaller or larger number of electromagnetic levitation control coils 405a-405b and 410a-410b may be employed. Finally, although in the previous embodiment, the upper levitator pole piece 126 includes four protruding steel poles 420, a different number or different structure of magnetic poles may be formed, while still remaining within the bounds of this invention.

Additionally, while in the previous description, four electromagnetic levitation control coils 405a-405b and 410a-410b are used, a further simplification of control coil structure may be constructed in which two coils are employed, one coil each being deployed for control of the X and Y axes, such that each coil is given a half-twist to form a “FIG. 8” topology before being installed around the four protruding poles of the controllable levitator pole in FIG. 4A. It will be apparent that a single current flow in an electromagnetic levitation control coil could reinforce the local magnetic field at one pole while opposing the local magnetic field at the opposite pole, thereby producing a differential attractive force which results in a torque on the opposed lower levitator pole assembly 510, consequently tilting the attached flywheel rotor assembly 170. This simplification reduces the number of required electromagnetic levitation control and associated coil drive electronics 205 and preserves the ability to tilt independently about the X and/or Y axes.

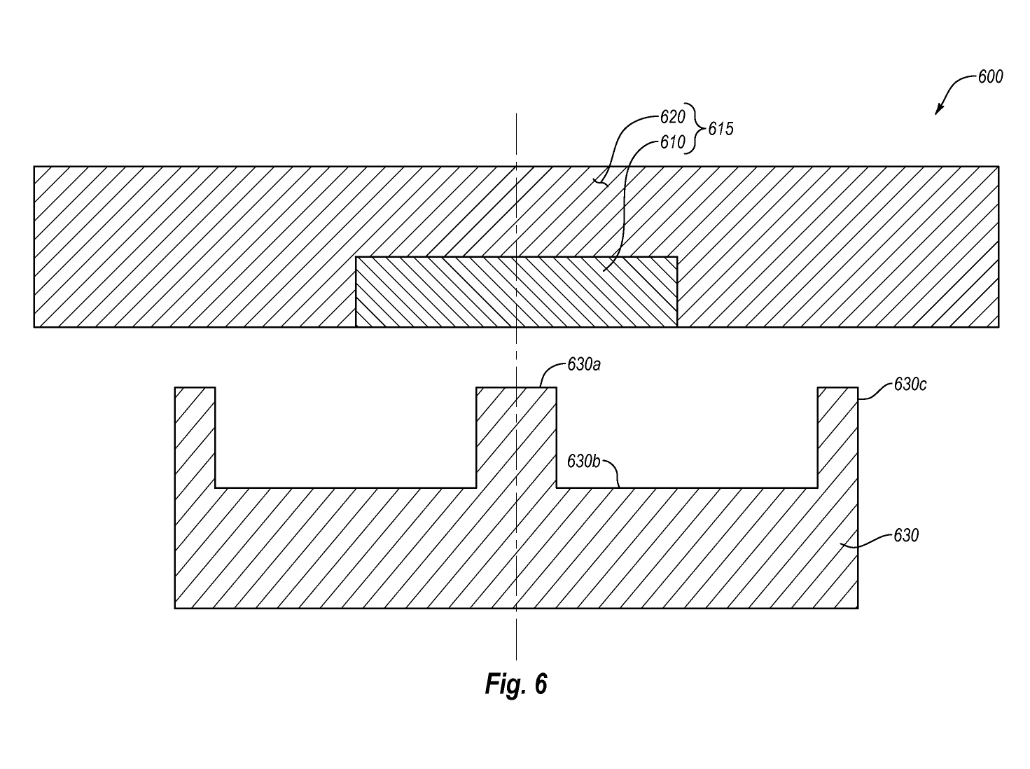

FIG. 6 depicts a schematically a controllable magnetic levitator system 600 according to a third embodiment which has a very low or substantially no restoring force in response to displacements of the lower levitator pole 630 in at least one of the X or Y axes. More specifically, the controllable magnetic levitator system 600 differs from the first and second embodiments described above in that the controllable magnetic levitator system 600 is designed so as to offer a minimum of restoring force in response to displacements of the lower levitator pole 630 and its attached flywheel rotor assembly 170 along the X and/or Y axes. As in the first embodiment, the controllable magnetic levitator system 600 operates to levitate a flywheel rotor against the force of gravity, and may be equipped with features as described in the second embodiment to enable control of rotor tilt as well as levitation.

This embodiment of the controllable levitator system 600 provides an additional utility in that it provides levitation and tilt without functioning as a magnetic bearing in the X and/or Y axes. More specifically, that is, the upper levitator pole 615 exerts substantially no radial restoring force on the lower levitator pole 630 and the attached rotor assembly 170 in response to small displacements of the rotor assembly 170 along the X and/or Y axes. This in turn permits the flywheel rotor assembly 170 to spin about its principal inertial axis, rather than a geometric spin axis that would be imposed if the levitation system 600 imposed radial restoring forces on the spinning rotor 150 of the flywheel rotor assembly 170. The absence of any radial restoring force that is synchronized to the rotor's rotational position and/or that is proportional to the degree of displacement of the rotor assembly 170 from the Z axis in the X and/or Y axes eliminates a range of detrimental instabilities that are well known in the art of rotating machinery, including subsynchronous swirl modes, synchronous rotor shaft bending modes, and other instabilities inherent to flywheels whose rotating components are supported by bearings.

In this configuration, the controllable upper magnetic levitator pole piece 620 is constructed from 1018 magnetic steel and has an outer diameter of 6 inches and a thickness of one inch. Provision is made for the attachment of a permanent magnet disc 610 disposed so as to be coplanar with the lower face of the controlled magnetic levitator pole piece 620 and the upper levitator pole 615 and concentric with its circular aspect as depicted in FIG. 6. Preferably, the permanent magnet disc 610 is made of a rare earth magnetic material of at least grade 42 and has a diameter of two inches and a thickness of 0.5 inches.

Although they are not shown in FIG. 6, electromagnetic levitation control coils are integrated into this structure in accord with the preferred embodiments described above, and are operative to effect modulation of levitation and tilt forces, and are incorporated but not described here, having been previously described.

The lower magnetic levitator pole 630 is constructed from 1018 magnetic steel, with an outer diameter of 4.5 inches, a maximum thickness of 1.375 inches, and having a central protruding cylindrical feature 510a with a diameter of one inch and a height above the adjacent planar surface 630b of 0.625 inches, the final descriptive geometric feature being an annulus 630c whose inner diameter is one inch and whose outer diameter is 3.75 inches, forming in sectional view the lower levitator pole 630 depicted in FIG. 6.

A controllable magnetic attractive force exists between the upper levitator pole assembly 615 and the lower levitator pole assembly 630 such that the lower levitator pole assembly 630 and the attached flywheel rotor assembly 170 may be levitated against the force of gravity and tilted as required.

For displacements comprising movements less than about 0.25 inches along the X and/or Y axes (radial displacements), it is found that little or substantially no restoring force is generated by the described controllable magnetic levitator system 600 described herein. That is, the magnetic levitator system 600 differs from a bearing which restricts movement in the radial direction, mitigating or eliminating a variety of detrimental effects known to arise in flywheels constrained by bearings. It will be recognized by those skilled in the art of magnetic suspension that the particular dimensions of this preferred embodiment are not controlling, and that other operable configurations may be formulated in accord with specific application requirements. This invention contemplates the use of other suitable magnetic materials and permanent magnet formulations, without limitation.

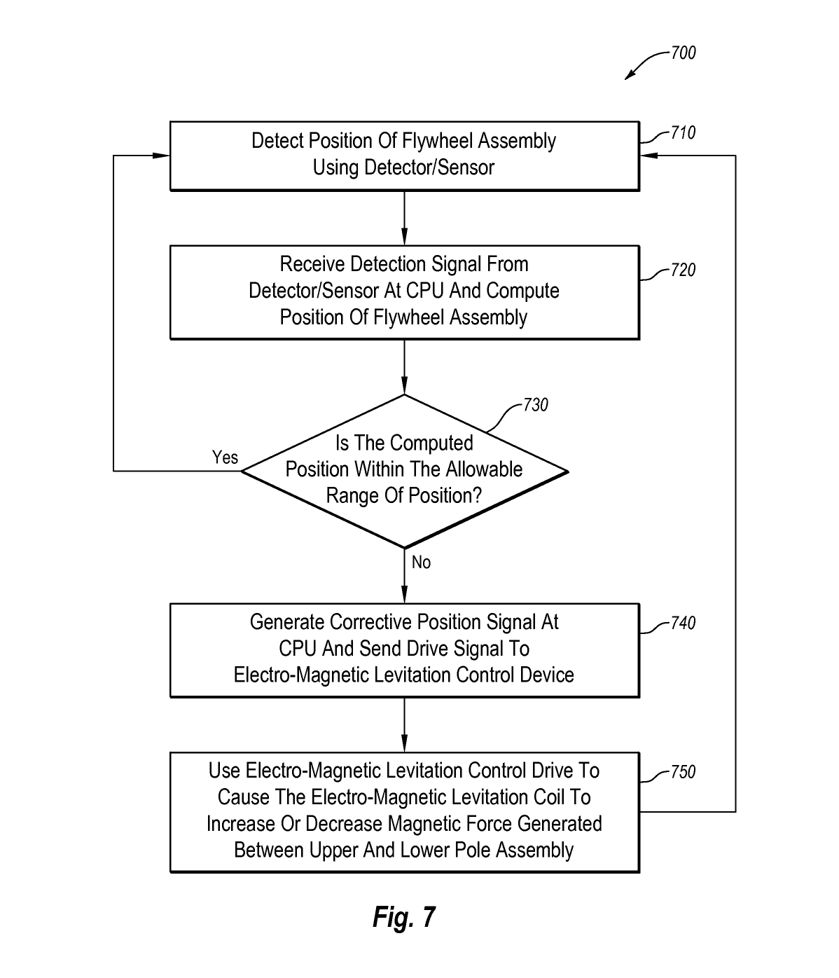

FIG. 7 is a flow chart illustrating a method 700 for controlling a controllable magnetic levitator system according to the embodiments described herein. In initial operation at 710, the position of the flywheel rotor assembly 170 is detected using the position sensor 175 with respect to the Z axis. This process may be repeated at a frequency which is determined by engineering requirements specific to the particular flywheel system. In this specific embodiment, the position of the flywheel rotor assembly 170 with respect to the Z-axis is sampled at recurrent intervals of approximately 12 microseconds. At 720, the signal from the position sensor or detector 175 is sent to a CPU 200 which receives the signal and subsequently computes a position of the flywheel assembly or otherwise converts the signal from the position sensor or detector 175 into a digital signal which is analyzed at 730. In one embodiment, the position of the flywheel rotor assembly 170 is recomputed by the CPU at recurrent intervals of approximately 4 milliseconds.

At 730, the CPU 200 analyzes the computed position or digital positional signal to determine if the computed rotor position is with an allowable range of rotor positions along the Z axis. In an alternative or additional embodiment, the CPU 200 may also or alternatively determine whether the computed rotor position in a predictive temporal series indicates that the flywheel rotor 170 will depart from the allowable Z axis position range in a predetermined period of time. If it is determined that the computed rotor position is within the acceptable range or if it is determined that the computed rotor position in a predictive temporal series indicates that the rotor will not depart from the allowable Z axis position range in a predetermined period of time, then the process returns to 710 and 720 where the detection and computation of the position of the flywheel assembly 170 with respect to the Z-axis continues.

Conversely, if at 720, the CPU 200 determines that the computed rotor position is not within the acceptable range or will fail outside the acceptable range in the predictive temporal series, then at 740 the CPU 200 generates a corrective position drive signal which is sent at to the levitator drive 205 which subsequently controls the causes the magnetic levitation control coil to increase or decrease the magnetic force generated between the upper levitator pole assembly 120 and the lower levitator pole assembly 110, thereby repositioning the flywheel rotor 170.

In the instant preferred embodiment, the rotor nominal Z axis position results in an face separation between the upper and lower levitation pole assemblies 110 and 120 of approximately 7 mm, and the range of acceptable Z axis rotor positions lies ±2 mm about this nominal preferred position.

In this preferred embodiment, a computation may also be performed at 710 to analyze temporal trends in the rotor assembly's 170 Z axis position and in the position control commands generated to maintain its position. This analysis is carried out in order to minimize the power required by the levitation control coil to maintain the rotor assembly's 170 position with respect to the Z axis.

For example, if the corrective control command history indicates that the electromagnetic levitation control coil has been commanded to continually weaken the levitation force generated by the two levitator permanent magnets, the rotor can be incrementally lowered along the Z axis to a position at which the levitation force provided by the permanent magnets alone is substantially adequate to levitate the rotor mass without requiring that the levitation control coil be energized. Similarly, if the corrective control command history indicates that the levitation control coil has been commanded to continually augment the levitation force generated by the two levitator permanent magnets, the rotor can be incrementally raised along the Z axis to a position at which the levitation force provided by the permanent magnets is substantially adequate to levitate the rotor mass without requiring that the levitation control coil be energized. This will be recognized as a computational implementation of the integration function of a PID controller. By this means, the rotor assembly 170 is levitated almost entirely through the force generated by the permanent magnets alone, minimizing power consumption by the levitation control system.

Although FIG. 7 describes a method for performing magnetic levitation using the embodiment shown in FIGS. 1-2D, a similar method may be performed using the embodiment shown in FIGS. 4A-4C and 5. In such a method, the position sensor 175 may detect the position of the flywheel rotor assembly 170 with respect to the X-axis and/or Y-axis in addition to detecting the position with respect to the Z-axis, and the CPU 200 may use this detected position to determine if the flywheel rotor assembly 170 is in an acceptable range of position along each of those axes. If it is determined that the flywheel rotor assembly 170 is not in an acceptable position, then the CPU 200 may send a corrective drive signal to the levitator drive 205 so as to increase or decrease the current applied to each of the independently operable electromagnetic levitation control coils 405a-405b and 410a-410b, so as to apply corrective forces between the upper levitator pole assembly 400 and the lower levitator pole assembly 510 in any of the X, Y, or Z axes.

In the embodiments described herein, the approximately 22 kg rotor assembly 170 can be sufficiently levitated with a levitation control coil power consumption of less than 3 watts. It will be apparent that this method is generally applicable to rotors of greater or lesser mass and permits controlled magnetic levitation of flywheel rotors with little energy required for levitation control.

The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for performing magnetic levitation of an energy storage flywheel, the system comprising:
an upper levitator pole which includes a permanent magnet, an electromagnet and a magnetic flux path of the permanent magnet;
a lower levitator pole fixed to the energy storage flywheel, the lower levitator pole being formed of a material capable of being attracted to or repelled from the upper levitator pole when a magnetic flux is applied to the magnetic flux path of the permanent magnet of the upper levitator pole;
an electromagnetic driver which applies an electric current through the electromagnet of the upper levitator pole; and
a controller which controls the electromagnetic driver so as to control the electric current applied through the electromagnet of the upper levitator pole so as to vary the magnetic flux applied to the magnetic flux path, causing the lower levitator pole to be controllably attracted to or repelled from the upper levitator pole.

2. The system of claim 1, wherein the upper levitator pole is fixed to a support structure capable of supporting the weight of the energy storage flywheel, while the lower levitator pole rotates with the energy storage flywheel.

3. The system of claim 1, further comprising a position detector which detects a position of the energy storage flywheel and wherein the controller controls the electromagnetic driver based on the detected position of the energy storage flywheel so that a corrective attractive or repulsive force is selectively applied between the upper levitator pole and the lower levitator pole.

4. The system of claim 1, wherein the upper levitator pole comprises a steel torus in which the permanent magnet and electromagnet are housed.

5. The system of claim 4, wherein the permanent magnet comprises a permanent ring magnet of a neodymium-iron-boron composition and the electromagnet comprises a magnet wire wound so as to fill an annulus formed between the permanent ring magnet and a surface of the upper levitator pole.

6. The system of claim 1, wherein the lower levitator pole comprises a steel torus in which a lower permanent ring magnet is housed with its north magnetic pole exposed so as to face an exposed surface of the permanent magnet of upper levitator pole.

7. The system of claim 6, wherein the lower levitator pole further comprises a reinforcement material which fills an annulus formed between the lower permanent ring magnet and a surface of the lower levitator pole so as to prevent the lower permanent ring magnet from fracturing due to centripetal forces produced as the energy storage flywheel is rotated.

8. The system of claim 1, wherein the upper levitator pole and the lower levitator pole provide a levitation force on the energy storage flywheel using the attractive force between the upper levitator pole and the lower levitator pole without applying a radial restoring force so as to confine the energy storage flywheel to rotate around a defined geometric axis.

9. A system for performing magnetic levitation of an energy storage flywheel, the system comprising:
an upper levitator pole which includes a permanent magnet, an magnetic flux path of the permanent magnet, and at least two independently operable electrical coils;
a lower levitator pole fixed to the energy storage flywheel, the lower levitator pole being formed of a material capable of being attracted to or repelled from the upper levitator pole when a magnetic flux is applied to the magnetic flux path of the permanent magnet of the upper levitator pole;
an electromagnetic driver which independently applies an electric current to each of the at least two independently operable electrical coils of the upper levitator pole; and
a controller which controls the electromagnetic driver so as to independently control the electric current applied through each independently operable electrical coils of the upper levitator pole so as to vary the magnetic flux applied to the magnetic flux path, causing the lower levitator pole to be controllably attracted to or repelled from the upper levitator pole.

10. The system of claim 9, further comprising a position detector which detects a position of the energy storage flywheel along at least two axes and wherein the controller controls the electromagnetic driver based on the detected position of the energy storage flywheel so that a corrective attractive or repulsive force is selectively applied between the upper levitator pole and the lower levitator pole along the at least two axes.

11. The system of claim 9, wherein the upper levitator pole comprises a steel torus in which the permanent magnet is housed, the upper levitator pole including a plurality of protruding poles around which the at least two independently operable electrical coils are wound.

12. The system of claim 11, wherein the permanent magnet comprises a permanent ring magnet of a neodymium-iron-boron composition.

13. The system of claim 9, wherein the position detector detects a position of the energy storage flywheel along at least two axes, the upper levitator pole comprises a steel torus in which the permanent magnet is housed and which includes four protruding poles around which the at least two independently operable electrical coils are wound, the controller controls the electromagnetic driver based on the detected position of the energy storage flywheel so that a corrective attractive or repulsive force is selectively applied between the upper levitator pole and the lower levitator pole along the at least two axes using the at least two independently operable electrical coils.

14. The system of claim 11, wherein the two at least independently operable electrical coils in a half-twist around the four protruding poles so as to form a figure eight topology.

15. The system of claim 9, wherein four independently operable electrical coils are each wound around a corresponding one of the four protruding poles so as to form two pairs of axis control electrical coils in for controlling the attractive or repulsive force, each of the pairs of axis control electrical coils controlling the attractive or repulsive force between the upper levitator pole and the lower levitator pole in one of the least two axes.

16. The system of claim 9, wherein the upper levitator pole and the lower levitator pole provide a levitation force on the energy storage flywheel using the attractive force between the upper levitator pole and the lower levitator pole without applying a radial restoring force so as to confine the energy storage flywheel to rotate around a defined geometric axis.

17. A method for performing levitation of an energy storage flywheel in a system including an upper levitator pole which includes a permanent magnet and an electromagnet, a lower levitator pole fixed to the energy storage flywheel, an electromagnetic driver, and a controller which controls the electromagnetic driver, the method comprising:
providing a levitation force on the energy storage flywheel by controlling the electromagnetic driver using the controller so that an electric current is applied through the electromagnet of the upper levitator pole so as to apply a magnetic flux to a magnetic flux path formed between the upper levitator pole and the lower levitator pole; and
causing the lower levitator pole to be controllably attracted to or repelled from the upper levitator pole by varying the electric current applied through the electromagnet of the upper levitator pole which varies the magnetic flux and attraction force between the upper levitator pole and the lower levitator pole.

18. The method of claim 17, further comprising detecting a position of the energy storage flywheel with respect to a first axis using a position detector and wherein the electromagnetic driver is controlled based on the detected position of the energy storage flywheel so that a corrective attractive or repulsive force is selectively applied between the upper levitator pole and the lower levitator pole in the direction of the first axis.

19. The method of claim 18, wherein:
the position of the energy storage flywheel is detected by the position detector along at least two axes,
the upper levitator pole comprises a steel torus in which the permanent magnet is housed and which includes four protruding poles around which at least two independently operable electrical coils comprising the electromagnet are wound,
the controller controls the electromagnetic driver based on the detected position of the energy storage flywheel so that a corrective attractive or repulsive force is selectively applied between the upper levitator pole and the lower levitator pole along the at least two axes using the at least two independently operable electrical coils.

20. The method of claim 17, wherein the levitation force on the energy storage flywheel is provided without applying a radial restoring force so as to confine the energy storage flywheel to rotate around a defined geometric axis.
